(19) United States
(12) Patent Application Publication
(10) Pub. No.: US 2011/0294363 A1
(43) Pub. Date: Dec. 1, 2011

(54) Terminal table fastener

(75) Inventor: Sheng-Hsing Yeh, Sijhid City (TW)

(73) Assignee: ANYTEK Technology Corporation, Ltd.

(21) Appl. No.: 11/980,751

(22) Filed: Oct. 31, 2007

(51) Int. Cl. H01R 9/22

(52) U.S. Cl. 439/709

(57) ABSTRACT

A terminal table fastener is provided which includes a housing, a fixing element, a resilient terminal and a screw element. The housing defines at least a chamber therein. The fixing element is inserted into the chamber, and the screw element screws to the fixing element for elevating the fixing element. A through hole is defined in the fixing element for accommodating a circuit wire. The resilient terminal is received in the chamber, and is inserted into the through hole for electrically contacting the circuit wire. The fixing element is integrally formed by forging iron and is heat processed to be seamless, and thus has high rigidity and large torque. The screw element extends into the through hole to press the circuit wire and the resilient terminal. The fixing element is elevated to clamp the circuit wire. The terminal table fastener therefore has optimal retention and effective electrical conduction.

### BACKGROUND OF THE INVENTION

(a) Field of the Invention

The present invention relates to a terminal table fastener, and particularly to a terminal table fastener used for connecting a circuit wire with a terminal wire on a terminal table.

(b) Description of the Prior Art

Terminal tables are popularly applied to circuit boards or other electronic appliances for transferring signals of a main board or a machine or receiving external signals. In prior art, a circuit wire is connected with a terminal. A hollow fastener is lifted by screws to make the circuit wire contact a touch plate.

The hollow fastener is so vital for connection between the circuit wire and the touch plate. Larger contact area of the circuit wires have, or closer the circuit wires are to the touch plate, lower impedance of the circuit has, and therefore more optimal transmission characteristics is achieved. An ordinary fastener is formed by stamping an iron sheet, often producing a slit. During the screws are pushed, the screws are often pressed to deform, influencing contact area. Other fasteners, such as fasteners made by forging zinc alloy or machining brass, are not hard enough, and can not bear expected torsion. Moreover, in process of forging, force is so large that takes risk of splitting or abrading teeth of the screws. So it needs much too cost and is uneconomical.

### SUMMARY OF THE INVENTION

To obviate the deficiencies above, an object of the present invention is to provide a terminal table fastener which has low cost, high rigidity and large torque, and which has optimal retention and reliable electrical conduction.

The terminal table fastener according to the present invention is adapted for electrically connecting a circuit wire, and comprises a housing, at least a fixing element, at least a resilient terminal and at least a screw element. The housing defines at least a chamber in a side thereof. The fixing element is integrally formed by forging iron, and is heat processed to be seamless. A through hole is defined in the fixing element for accommodating the circuit wire. A screw hole is defined in a top of the fixing element and communicates with the through hole. The resilient terminal is fixed in the chamber of the housing, and is extended into the through hole for electrically contacting the circuit wire. A screw element is screwed through the screw hole, and extends into the through hole for pressing the circuit wire and resilient terminal.

### BRIEF DESCRIPTION OF THE DRAWINGS

FIG. 1 is an exploded view of a terminal table fastener according to the present invention.

FIG. 2 is a schematic cross sectional view of the terminal table fastener of FIG. 1, wherein the terminal table fastener is operated at a first state.

FIG. 3 is another schematic cross sectional view of the terminal table fastener of FIG. 1, wherein the terminal table fastener is operated at a second state.

### DETAILED DESCRIPTION OF THE PREFERRED EMBODIMENTS

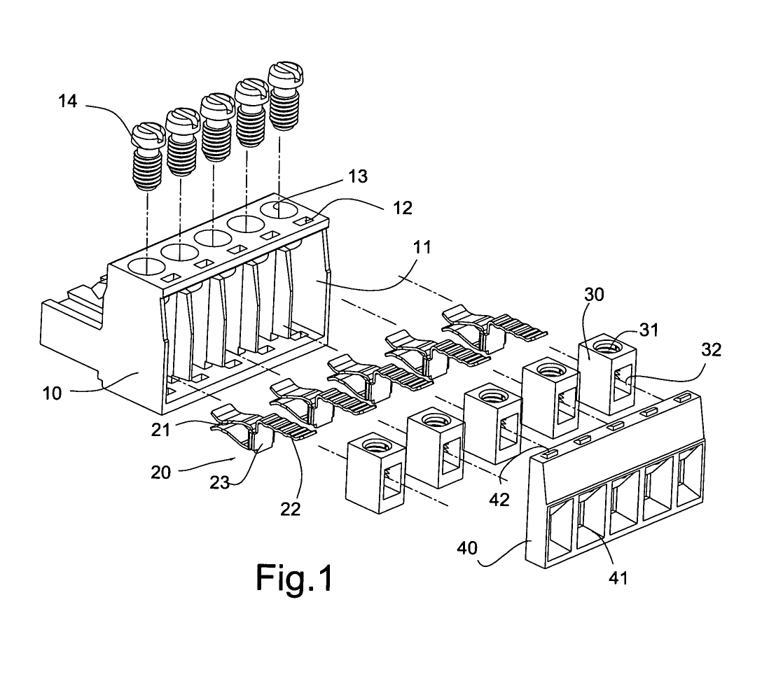

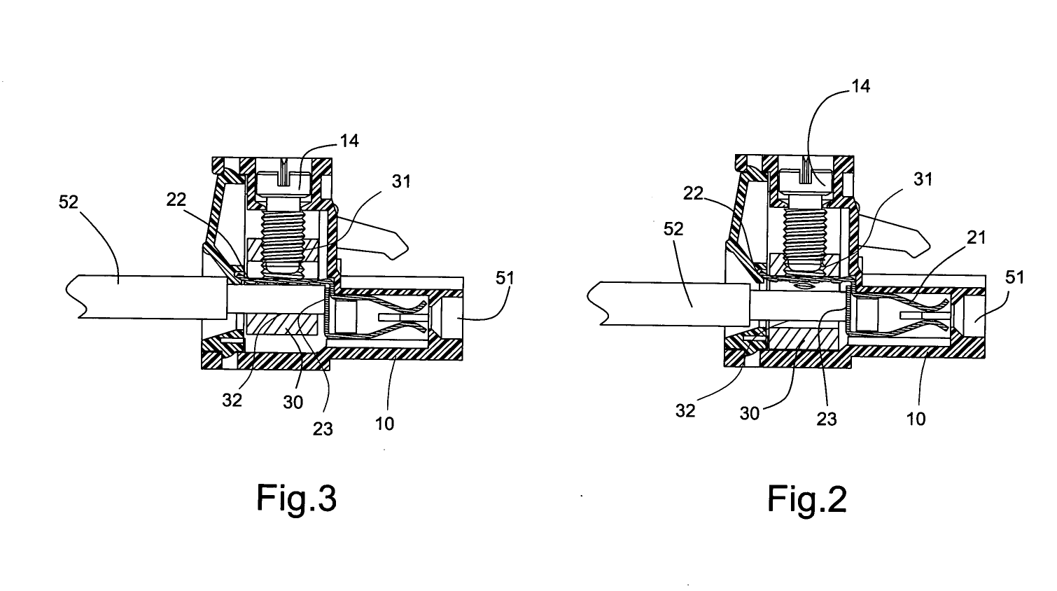

Referring to FIG. 1, a terminal table fastener in accordance with the present invention comprises a housing 10, at least a resilient terminal 20, at least a fixing element 30 and at least a screw element 14. At least a chamber 11 is defined through the housing 10. A rectangular hole 12 and a circular hole 13 are respectively defined in the housing 10 and communicate with the chamber 11. Each resilient terminal 20 forms a clamp 21 at a rear end thereof for retaining a terminal wire 51 (shown in FIGS. 2 and 3), and a touch plate 22 at a front end thereof. An abutting portion 23 is formed between the clamp 21 and the touch plate 22 for abutting against the fixing element 30. Each fixing element 30 defines a through hole 32 through a front face and a rear face thereof. In assembly, the abutting portion 23 extends into the through hole 32 of the fixing element 30 to electrically contact a circuit wire 52 (shown in FIGS. 2 and 3). Each fixing element 30 further defines a screw hole 31 at a top thereof for cooperating with the screw element 14. A plastic cover 40 is provided to cover a side of the housing 10. The plastic cover 40 forms at least a tenon 42 for inserting into the rectangular hole 12. At least an opening 41 is defined in the plastic cover 40 for corresponding to the through hole 32 of the fixing element 30.

Referring to FIG. 2, the terminal wire 51 is put into and is held by the clamp 21. The circuit wire 52 extends through the through hole 32 of the fixing element 30 and below the touch plate 22 for abutting against the abutting portion 23. The screw element 14 is inserted through the circular hole 13 and the screw hole 31, and into the through hole 32. The screw element 14 turns around relative to the fixing element 30, driving the fixing element 30 to go up. As shown in FIG. 3, the fixing element 30 forces the circuit wire 52 to contact the touch plate 22. Under pressure of the screw element 14, the circuit wire 52 contacts the touch plate 22 closely, thereby assuring reliable electrical connection.

The fixing element 30 is integrally formed by forging iron, and is heat processed to be seamless. Therefore, the fixing element 30 has low cost and high rigidity, and is capable of undergoing large torque. The screw element 14 presses and fixes the circuit wire 52 and the resilient terminal 20. The circuit wire 52 is urged to contact the touch plate 22 firmly, obtaining effective electrical conduction.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A terminal table fastener adapted for electrically connecting a circuit wire, comprising:
a housing defining at least a chamber;
a fixing element being integrally formed by forging iron, and being heat processed to be seamless, a through hole being defined in the fixing element for accommodating the circuit wire, a screw hole being defined in a top of the fixing element and communicating with the through hole;
a resilient terminal being fixed in the chamber of the housing, and being extended into the through hole for electrically contacting the circuit wire; and
a screw element being screwed through the screw hole, and extending into the through hole for pressing the circuit wire and resilient terminal.

2. The terminal table fastener as recited in claim 1, wherein the resilient terminal retains a terminal wire at a rear end thereof.

3. The terminal table fastener as recited in claim 1, wherein the resilient terminal forms a clamp at a rear end thereof for retaining a terminal wire, and a touch plate at a front end thereof, an abutting portion being formed between the clamp and the touch plate, and in assembly, extending into the through hole of the fixing element to electrically contact the circuit wire.

4. The terminal table fastener as recited in claim 1, wherein a plastic cover is provided to cover a front side of the housing, an opening being defined in the plastic cover for corresponding to the through hole of the fixing element, the circuit wire extending through the opening and into the through hole.

5. The terminal table fastener as recited in claim 4, wherein the housing defines at least a rectangular hole, and the plastic cover forms at least a tenon for inserting into the rectangular hole, whereby the plastic cover is fixed to the housing.
